(19) United States
(12) Patent Application Publication
(10) Pub. No.: US 2010/0170063 A1
(43) Pub. Date: Jul. 8, 2010

(54) HINGE AND ELECTRONIC DEVICE WITH HINGE

(75) Inventor: Shun-Yu Hung, Shulin City (TW)

Correspondence Address: APEX JURIS, PLLC, 12733 LAKE CITY WAY NORTHEAST, SEATTLE, WA, 98125, US

(73) Assignee: SHIN ZU SHING CO., LTD., Shulin City (TW)

(21) Appl. No.: 12/350,100

(22) Filed: Jan. 7, 2009

(51) Int. Cl. E05D 11/10

(52) U.S. Cl. 16/343

(57) ABSTRACT

A hinge has a main frame, a pivoting bracket and a limiting assembly The main frame is attached to a base of an electronic device. The pivoting bracket is attached to a cover of the electronic device and has a rotating rod being mounted through the main frame. The limiting assembly has a first actuator, a second actuator and a guiding pin. The first and second actuators are rotated relative to each other. The guiding pin is mounted between the first and second actuators and is moved relative to the actuators to allow the cover to be rotated clockwise and anticlockwise by 180 degrees, relative to the base. Therefore, a screen on the cover can be adjusted at wishes.

### BACKGROUND OF THE INVENTION

1. Field of the Invention

The present invention relates to a hinge and an electronic device with the hinge, especially to a hinge that is mounted between a cover and a base of the electronic device to allow the cover to be rotated clockwise or anticlockwise 180 degrees relative to the base.

2. Description of the Prior Arts

Conventional portable electronic devices such as notebook computers, cell phones and the like comprise a cover, a base and a conventional hinge. The conventional hinge is mounted between the cover and the base to allow the cover to be tilted and rotated relative to the base. To protect internal electrical wires, the conventional hinge has a limiting structure to prevent the cover from over rotating. The limiting structure comprises a stationary limit and a rotating limit respectively connected to the base and the cover. So when the cover is rotated about a longitudinal axis for users to view a screen at wishes, the rotating limit abuts the stationary limit to limit the rotation of the cover.

Conventionally, both the rotating limit and the stationary limit have certain, tangible sizes, and are firmly provided on the cover and base respectively so that those elements, though they prevent the wires from damages, result that cover can not be exactly rotated clockwise and anticlockwise 180 degrees relative to the base. There are several ways to overcome the shortcomings, but most are with complicated designs.

Therefore, the present invention provides a hinge and an electronic device with the hinge to mitigate or obviate the aforementioned problems.

### SUMMARY OF THE INVENTION

The main objective of the present invention is to provide a hinge and an electronic device with the hinge that allows the cover to be rotated clockwise or anticlockwise by 180 degrees relative to the base.

The hinge has a main frame, a pivoting bracket and a limiting assembly. The main frame and the pivoting bracket are respectively attached to a base of and a cover of the electronic device, and are rotatable relative to each other. The limiting assembly comprises a first actuator, a second actuator and a guiding pin. The first and second actuators are respectively and alternatively mounted either on the main frame or on the pivoting bracket. The guiding pin is moveably and alternatively mounted on either the first actuator or the second actuator, and is pushed when two actuators are rotated relative to each other.

With relative movement between the first and second actuators, the cover can be rotated clockwise or anticlockwise by 180 degrees, relative to the base. Therefore, the screen on the cover can be adjusted by users as wishes, and this will not damage the wires inside the hinge.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is a partially exploded perspective view of the hinge in FIG. 1;

FIGS. 3a, 3b and 3c are top operational views of the hinge in FIG. 1 showing clockwise rotation of the hinge;

FIGS. 4a, 4b and 4c are top operational views of the hinge in FIG. 1 showing anti-clockwise rotation of the hinge;

FIG. 5 is a perspective view of another embodiment of a-hinge in accordance with the present invention;

FIG. 6 is a partially exploded perspective view of the hinge in FIG. 5;

FIGS. 7a, 7b and 7c are top operational views of the hinge in FIG. 5 showing clockwise rotation of the hinge;

FIGS. 8a, 8b and 8c are another top operational view of the hinge in FIG. 5 showing anti-clockwise rotation of the hinge; and

FIG. 9 is a perspective view of an electronic device in accordance with the present invention with the hinge in FIG. 5.

### DETAILED DESCRIPTION OF THE PREFERRED EMBODIMENTS

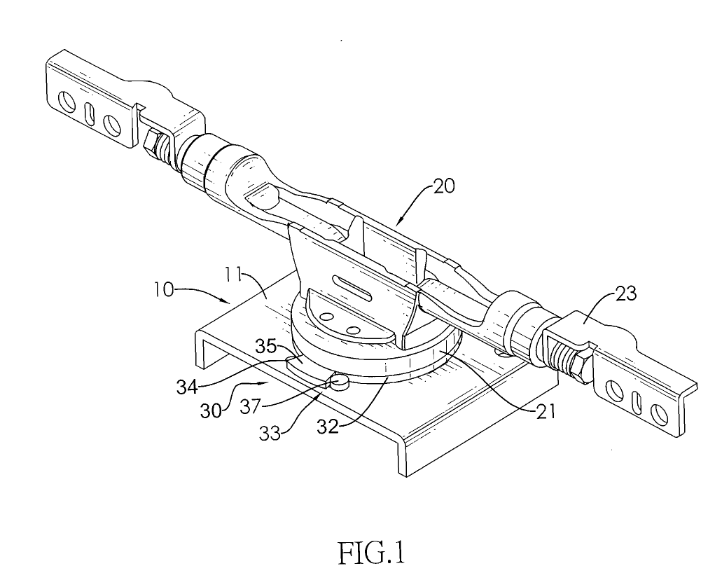

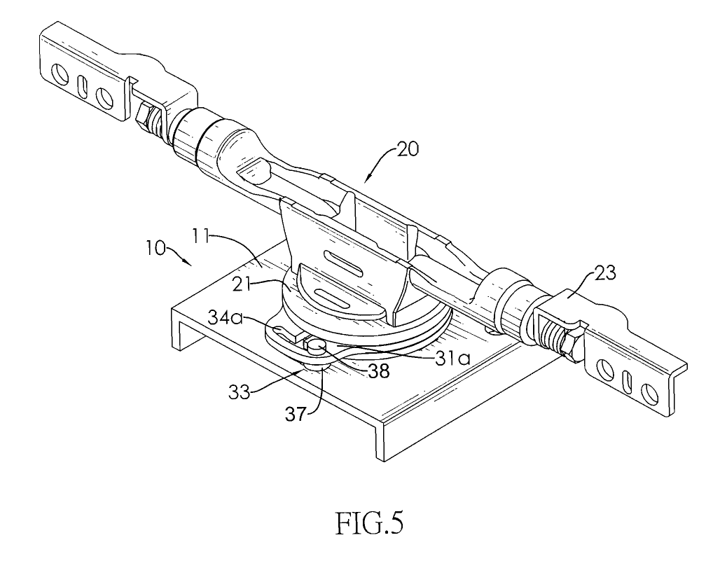

With reference to FIGS. 1, 2, 5 and 6, a hinge in accordance with the present invention comprises a main frame (10), a pivoting bracket (20), a limiting assembly (30) and a washer assembly (40).

The main frame (10) may be U-shaped and has a seat (11) defined a pivoting hole (12) and two positioning detents (13) thereon. The positioning detents (13) may penetrate the seat (11) to communicate with the pivoting hole (12).

The pivoting bracket (20) is pivotally connected to the main frame (10), and has a body (21), a rotating rod (22) extended downward thereof and two ends extended outward thereof. The rotating rod (22) may have a non-circular shape in cross section, and is mounted rotatably through the pivoting hole (12) of the seat (11). Two tilting assemblies (23) are pivotally attached to the ends of the body (21).

The limiting assembly (30) is connected to the main frame (10) and the pivoting bracket (20) and has a first actuator (31, 31a), a second actuator (32, 32a) and a guiding pin (33).

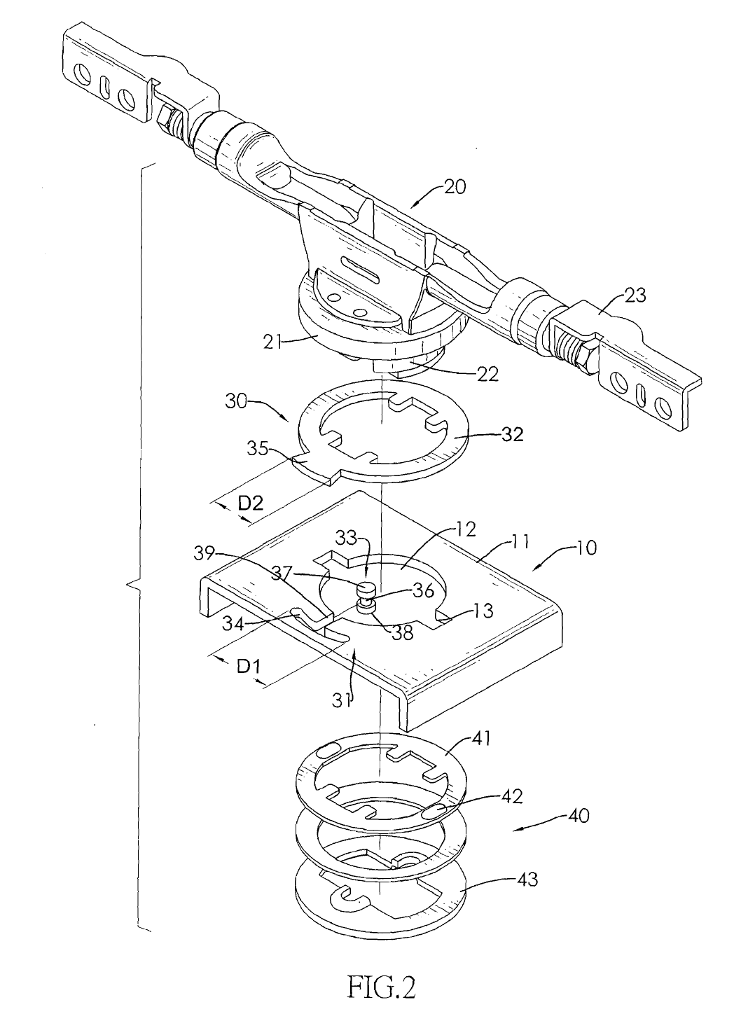

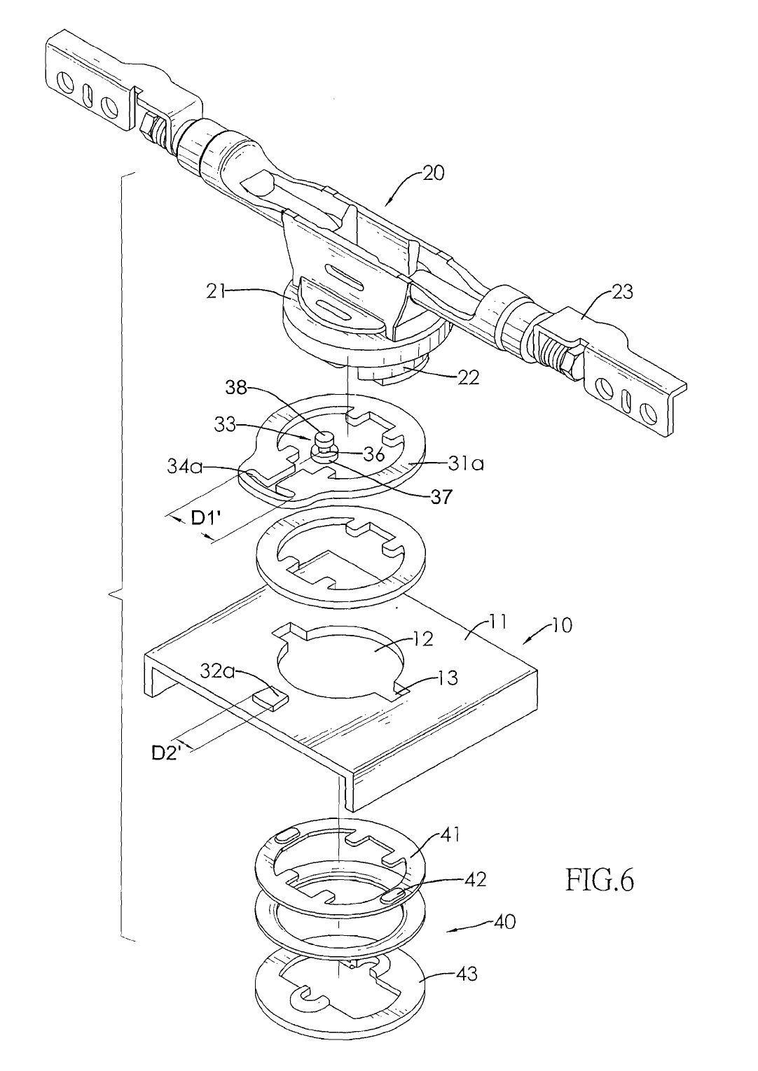

As shown in FIGS. 2 and 6, the first actuator (31, 31a) and the second actuator (32, 32a) are respectively and alternatively provided either on the main frame (10) or on the rotating rod (22) of the pivoting bracket (20).

Selectively, the first actuator (31) may be a slot (34) defined on the seat (11) of the main frame (10), or the first actuator (31a) may be a washer having a slot (34a) defined thereon, firmly attached to the rotating rod (22) of the pivoting bracket (20).

Selectively, the second actuator (32) may be a washer with a limiting protrusion (35) extended thereof, firmly attached to the rotating rod (22) of the pivoting bracket (20), or the second actuator (32a) may be a limiting block provided on the seat (11) of the main frame (10).

The guiding pin (33) is moveably and alternatively mounted either on the slot (34) of first actuator (31) or on the slot (34a) of the first actuator (31a), and is pushed when two actuators (31,31a,32,32a) are rotated relative to each other.

The guiding pin (33) may have a neck (36), a first head (37) and a second head (38). The first head (37) and the second head (38) are detachably attached on two ends of the neck (36) to easily assemble the guiding pin (33) on the slot (34,34a). Preferably, the first head (37) and the second head (38) abut the surfaces of the main frame (10), or abut the surfaces of the first actuator (31a) to keep the stable movement of the guiding pin (33) along the slot (34,34a).

Preferably, the first actuator (31) is defined thereon with an elongate passage (39) to communicate the pivoting hole (12) and the slot (34), or the first actuator (3 la) is provided with an elongate passage (39) communicating the slot (34a) to easily assemble the guiding pin (33) thereon.

In the present embodiment, the slot (34, or 34a) of the first actuator (31, or 31a) has a predetermined width (D1, or D1′). The width (D1, or D1′)of the slots (34, or 34a) of the first actuator (31, or 31a) is roughly equivalent to a width (D2,or D2′) of the limiting protrusion (35)/the limiting block (32a) plus a width of the guiding pin (33). However, the width (D1, D1′) of the slot (34,34a) of the first actuator (31,31a) varies depending on desired rotating ranges between the pivoting bracket (20) and the main frame (10).

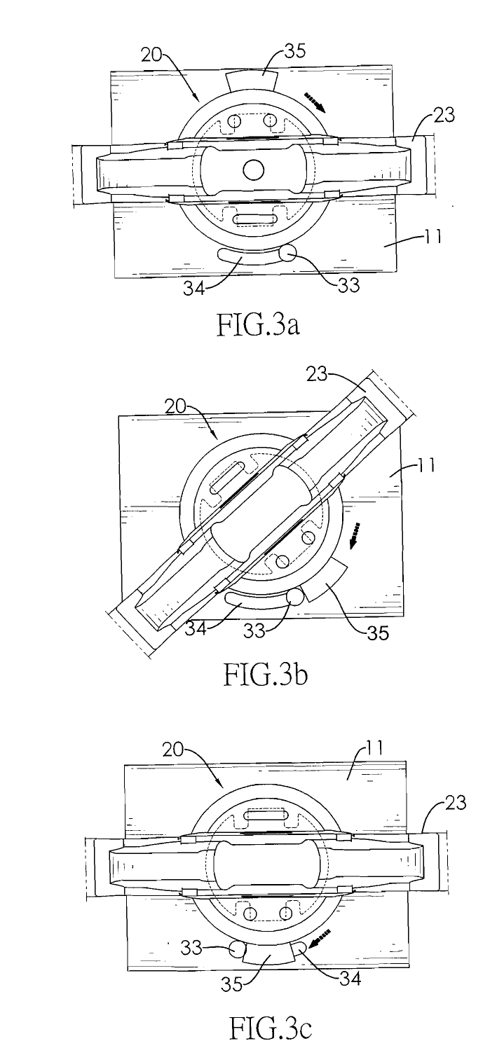

With further reference to FIGS. 3a to 3c, the pivoting bracket (20) rotated clockwise relative to the seat (11) simultaneously causes the limiting protrusion (35) of the second actuator (32) to push the guiding pin (33) to slide along the slot (34) until the guiding pin (33) against one end of the slot (34).

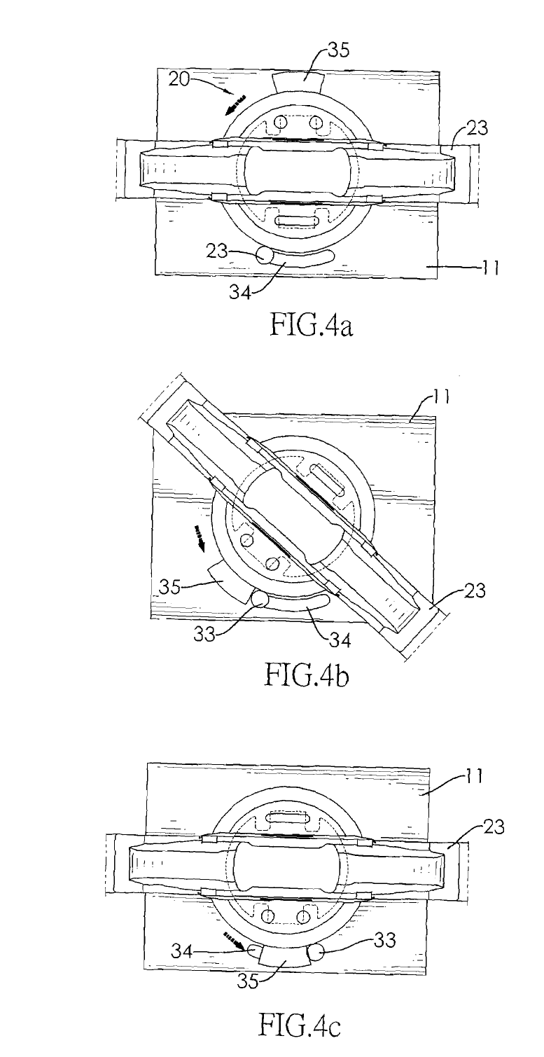

As shown in FIGS. 4a to 4c, the pivoting bracket (20) rotated anticlockwise relative to the seat (11) also pushes the guiding pin (33) to slide along the slot (34) until the guiding pin (33) against other end of the slot (34).

Therefore, the pivoting bracket (20) is able to be rotated clockwise or anticlockwise by 180 degrees relative to the base, and is stopped rotating when guiding pin (33) against the ends of the slot (34) to prevent wires inside the hinge from damage.

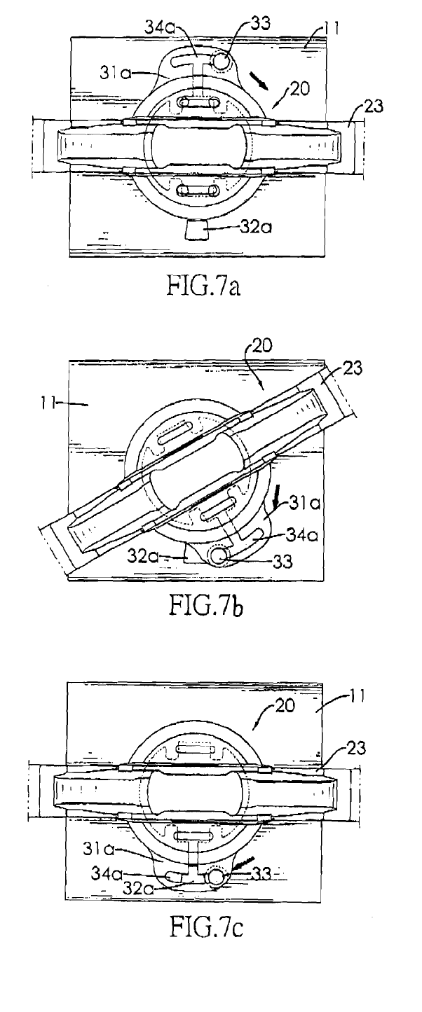

With further reference to FIGS. 7a to 7c, the pivoting bracket (20) rotated clockwise relative to the seat (11) also makes the guiding pin (33) pushed by the limiting block of the second actuator (32a) to slide along the slot (34a) until the guiding pin (33) against one end of the slot (34a).

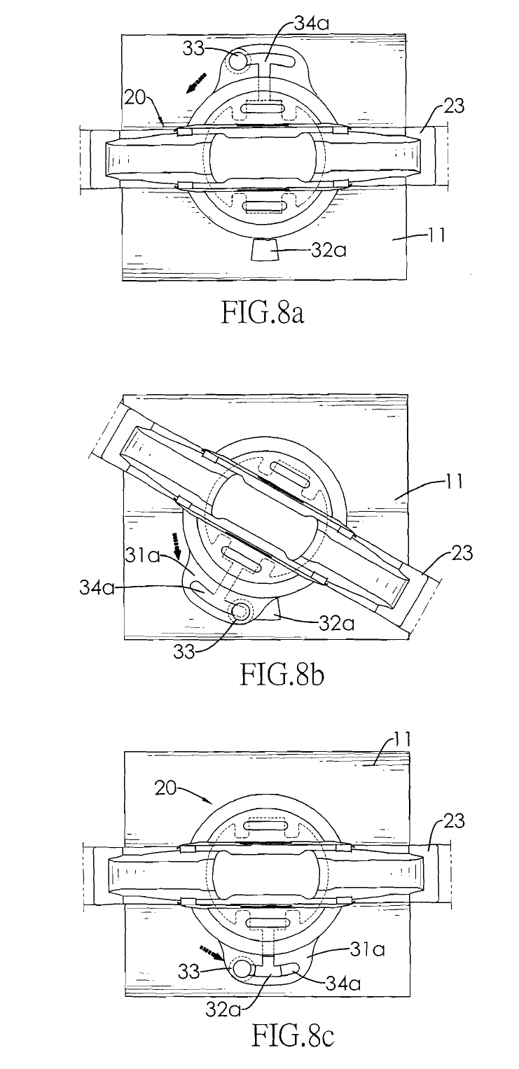

Likewise, the pivoting bracket (20) rotated anticlockwise relative to the seat (11) also makes the guiding pin (33) sliding along the slot (34a) until the guiding pin (33) against other end of the slot (34a) as shown in FIGS. 8a to 8c.

The washer assembly (40) is mounted around the rotating rod (22), and comprises a positioning washer (41) and a fastening washer (43). The positioning washer (41) is mounted non-rotatably around the rotating rod (22), and is provided with two positioning protrusions (42) thereon to selectively engage the positioning detent (13) of the seat (11) to position the rotating rod (22).The fastening washer (43) is attached securely around the rotating rod (22) to fasten the pivoting bracket (20) to the main frame (10).

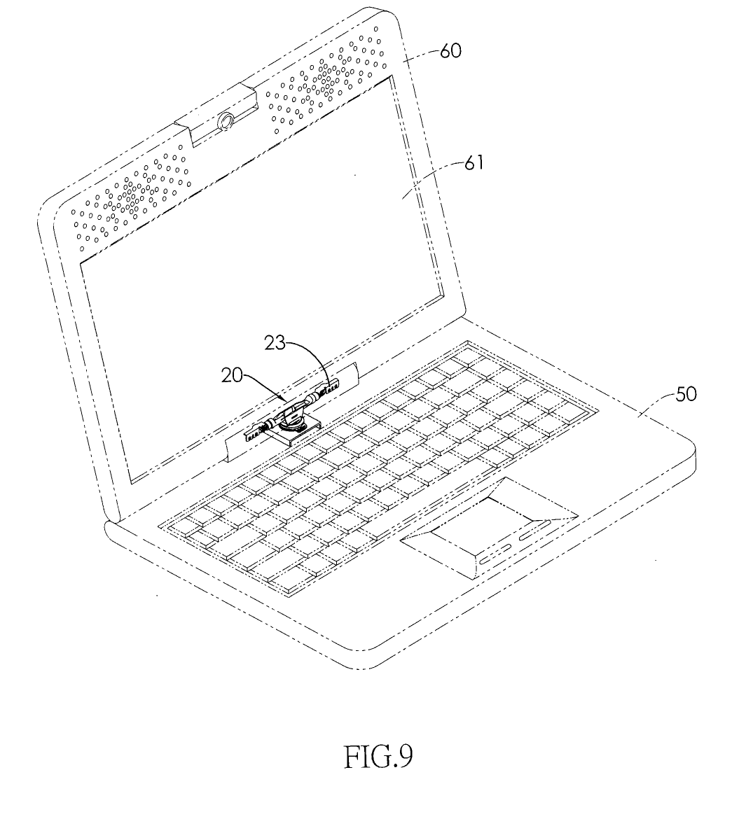

With further reference to FIG. 9, an electronic device in accordance with the present invention comprises a base (50), a hinge as described and a cover (60). The main frame (10) of the hinge is fastened to the base (50), and the tilting assembly (23) of the pivoting bracket (20) of the hinge is attached to the cover (30) to allow the cover (60) to be opened away or closed toward the base (50).

In open position, when the pivoting bracket (20) rotates about a longitudinal axis, the limiting assembly (30) limits the rotating angle of the cover (60) and allows the cover (60) to rotate clockwise or anticlockwise 180 degrees relative to the base (50). Also, the limiting assembly (30) prevents the wires from damages.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a pivoting bracket having a rotating rod extended thereof;
a main frame having a pivoting hole for receiving the rotating rod therethrough; and
a limiting assembly connected to the main frame and the pivoting bracket, the limiting assembly having a first actuator, a second actuator and a guiding pin;
wherein the first actuator and the second actuator are respectively and alternatively provided either on the main frame or on the pivoting bracket; and
wherein the guiding pin is moveably mounted on the first actuator, and is pushed by the second actuator when two actuators are rotated relative to each other.

2. The hinge as claimed in claim 1, wherein the first actuator is a slot defined on the main frame, and the second actuator is a wash with a limiting protrusion formed thereof to push the guiding pin.

3. The hinge as claimed in claim 2, wherein the slot has a predetermined width that roughly equals to a width of the limiting protrusion plus a width of the guiding pin.

4. The hinge as claimed in claim 2, wherein the main frame has an elongate passage defined to communicate the pivoting hole and the slot.

5. The hinge as claimed in claim 1, wherein the first actuator is a wash with a slot defined thereon, and the second actuator is a limiting block formed on the main frame.

6. The hinge as claimed in claim 5, wherein the slot has a predetermined width that roughly equals to a width of the limiting block plus a width of the guiding pin.

7. The hinge as claimed in claim 5, wherein the first actuator is provided with an elongate passage communicating the slot to easily assemble the guiding pin thereon.

8. The hinge as claimed in claim 1, wherein the guiding pin has a neck, a first head and a second head, the first head and the second head being detachably attached on two ends of the neck respectively.

9. The hinge as claimed in claim 8, wherein the first head and the second head abut two surfaces of the first actuator.

10. The hinge as claimed in claim 1, wherein the hinge comprises a washer assembly to fasten the main frame to the pivoting bracket.

11. The hinge as claimed in claim 10, wherein the washer assembly further comprises a positioning washer attached to the rotating rod, the positioning washer having at least one positioning protrusion to selectively engage a positioning detent defined on the main frame.

12. The hinge as claimed in claim 1, wherein the hinge comprises two tilting assemblies being respectively and pivotally attached to the pivoting bracket.
